(19) United States
(12) Patent Application Publication
(10) Pub. No.: US 2023/0155395 A1
(43) Pub. Date: May 18, 2023

(54) SYSTEM AND METHOD WITH A DIRECT CURRENT TO DIRECT CURRENT (DC/DC) CONVERTER

(71) Applicant: Proterra Operating Company, Inc., Burlington, CA (US)

(72) Inventor: Kurt NOLTE, Greenville, SC (US)

(73) Assignee: Proterra Operating Company, Inc., Burlingame, CA (US)

(21) Appl. No.: 17/529,596

(22) Filed: Nov. 18, 2021

(51) Int. Cl. H02J 7/00; B60L 53/20; B60L 58/22

(52) U.S. Cl. CPC H02J 7/0014; H02J 7/00032; H02J 7/00712; H02J 7/0048; B60L 53/20; B60L 58/22; H02J 2207/20; B60L 2210/10

(57) ABSTRACT

A battery system may include at least one battery pack including a direct current to direct current (DC/DC) converter and at least one battery cell. A positive terminal and a negative terminal of the at least one battery cell may be electrically connected to a positive terminal and a negative terminal, respectively, associated with the DC/DC converter. The battery system may further include a high voltage bus bar electrically connected to the positive terminal and the negative terminal of the at least one battery cell and a low voltage bus bar electrically connected to the DC/DC converter. The DC/DC converter may be configured to import power to the at least one battery cell from, or export the power to, the low voltage bus bar. The battery system may additionally include a communication bus bar electrically connected to the DC/DC converter.

### TECHNICAL FIELD

Embodiments of this disclosure relate to a battery system and, more particularly, to a battery system that includes a direct current to direct current (DC/DC) converter.

### BACKGROUND

High voltage batteries (e.g., batteries of 100 volts of direct current (Vdc) potential or more that are used to supply direct current (DC)) are used to recharge and sustain low voltage operations (e.g., operations that rely on about 50 Vdc or less) while a vehicle is in operation. For instance, these types of systems may use a standalone DC/DC converter that is external to the high voltage battery system to convert the high voltage DC to low voltage DC. While the vehicle is in an idle state (high voltage deactivated), the high voltage bus bar is not energized, and the contactors within the battery packs are disengaged for safety. This can help prevent accidental exposure to high voltage, as well as reduce the risk of a high energy short. This practice, however, does prevent the energy in the high voltage batteries from being used to sustain various important devices and systems that are activated even when the vehicle is not being used (e.g., “keep alive” systems, such as a fire suppression system or an anti-theft system). By using an external DC/DC converter, the pack contactors have to be energized to deliver power, nullifying the safety of the previously described practice. This also increases an electric load of an idle vehicle by the amount of energy needed to keep the battery contactors activated, thereby causing the vehicle to consume excess power.

In addition, battery systems that include strings of multiple battery packs connected in series can experience issues where battery pack voltages within a string are not equal. This can produce operational problems because the individual battery cell voltages are closer to the upper and lower extremes than the rest of the battery system, which can limit charging and discharging power. Such battery pack imbalance problems can be addressed in the maintenance shop, typically by connecting an external equipment to one or more of the battery packs in the battery system, and discharging the excess energy from those battery packs to reduce their stored energy and bring their stored energy into balance with the rest of the battery packs in the string. The whole string of battery packs may then be charged up independently before it is reconnected to another parallel string on the vehicle. Thus, balancing stored energy levels among multiple battery packs of a vehicle requires external equipment and can waste stored energy in the form of discharged energy. Embodiments of the current disclosure may address these limitations and/or other problems in the art.

### SUMMARY

Embodiments of the present disclosure relate to, among other things, battery systems for electric vehicles. Each of the embodiments disclosed herein may include one or more of the features described in connection with any of the other disclosed embodiments.

In one embodiment, a battery system may include at least one battery pack including a direct current to direct current (DC/DC) converter and at least one battery cell. A positive terminal and a negative terminal of the at least one battery cell may be electrically connected to a positive terminal and a negative terminal, respectively, associated with the DC/DC converter. The battery system may further include a high voltage bus bar electrically connected to the positive terminal and the negative terminal of the at least one battery cell and a low voltage bus bar electrically connected to the DC/DC converter. The DC/DC converter may be configured to at least one of import power to the at least one battery cell from the low voltage bus bar or export the power from the at least one battery cell to the low voltage bus bar. The battery system may additionally include a communication bus bar electrically connected to the DC/DC converter and at least one computing system configured to communicate with the DC/DC converter via the communication bus bar.

In another embodiment, a method of using a direct current to direct current (DC/DC) converter located within a battery pack of a battery system, where the DC/DC converter may be electrically connected to a low voltage bar and to one or more battery cells of the battery pack, may include receiving, by a computing system, an instruction to activate the DC/DC converter. The method may further include sending one or more instructions to the DC/DC converter. The one or more instructions may be associated with configuring the DC/DC converter at least to operate based on a set of parameters including a direction or an amount of power flow import to or export from the battery pack.

In another embodiment, a method for balancing stored energy levels among a plurality of battery packs of a battery system may include receiving, by a computing system, one or more first instructions to activate a plurality of direct current to direct current (DC/DC) converters. Each of the plurality of battery packs may include at least one of the plurality of DC/DC converters. The method may additionally include receiving information related to the stored energy levels of the plurality of battery packs. The method may further include determining, for each of the plurality of battery packs, a direction of power flow and an amount of the power flow to balance the stored energy levels among the plurality of battery packs and sending one or more second instructions to each of the plurality of DC/DC converters. The one or more second instructions may be associated with configuring the each of the plurality of DC/DC converters to operate based on a set of parameters including the direction and the amount of the power flow.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIGS. 1A and 1B illustrate an exemplary electric bus having a battery system, according to the present disclosure;

FIG. 2 is a schematic illustration of an exemplary battery system of the bus of FIGS. 1A and 1B, according to the present disclosure;

FIG. 3 is a schematic illustration of an exemplary battery module of the battery system of FIG. 2, according to the present disclosure;

FIG. 4 is a schematic illustration of connections between the battery pack of FIG. 2 and peripheral devices or systems of the bus of FIGS. 1A and 1B, according to the present disclosure;

FIG. 5 is a schematic illustration of a battery pack of the battery system of FIG. 2 that includes a DC/DC converter, according to the present disclosure;

FIG. 6 is another schematic illustration of a battery pack of the battery system of FIG. 2 that includes a DC/DC converter, according to the present disclosure;

FIG. 7 is a schematic illustration of power export from battery packs of FIG. 6 with balanced stored energy levels, according to the present disclosure;

FIG. 8 is a schematic illustration of power import to, and power export from, battery packs of FIG. 6 with imbalanced stored energy levels, according to the present disclosure;

FIG. 9 is another schematic illustration of power import to, and power export from, battery packs of FIG. 6 with imbalanced stored energy levels, according to the present disclosure;

FIG. 10 illustrates an exemplary method of enabling a DC/DC converter included in a battery pack of FIG. 6, according to the present disclosure;

FIG. 11 illustrates an exemplary method of balancing stored energy levels among multiple battery packs of FIG. 6, according to the present disclosure; and

FIG. 12 illustrates example components of a computing device, according to the present disclosure.

### DETAILED DESCRIPTION

The present disclosure describes a system and method for a battery system including a DC/DC converter. While principles of the current disclosure are described with reference to an electric bus, it should be understood that the disclosure is not limited thereto. Rather, the systems and methods of the present disclosure may be used in any vehicle having a battery system (e.g., electric vehicle, electric machine, electric tool, electric appliance, etc.). As used herein, the term “electric vehicle” includes any vehicle or transport machine that is driven at least in part by electricity (e.g., hybrid vehicles, all-electric vehicles, etc.). Heavy duty electric vehicles (e.g., electric buses, electric trucks, electric airplanes, electric boats, etc.) may store and/or consume a large amount of energy compared to smaller electric vehicles (e.g., electric cars, electric bicycles or motorcycles, electric carts, etc.).

In this disclosure, relative terms, such as “about,” “substantially,” or “approximately” are used to indicate a possible variation of ±10% of a stated value.

Any implementation described herein as exemplary is not to be construed as preferred or advantageous over other implementations. Rather, the term “exemplary” is used in the sense of example or illustrative.

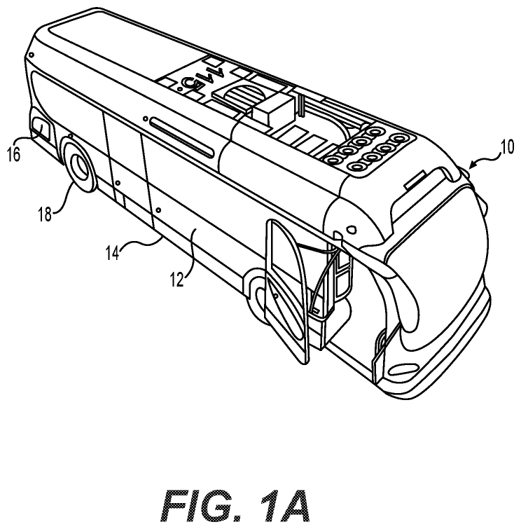

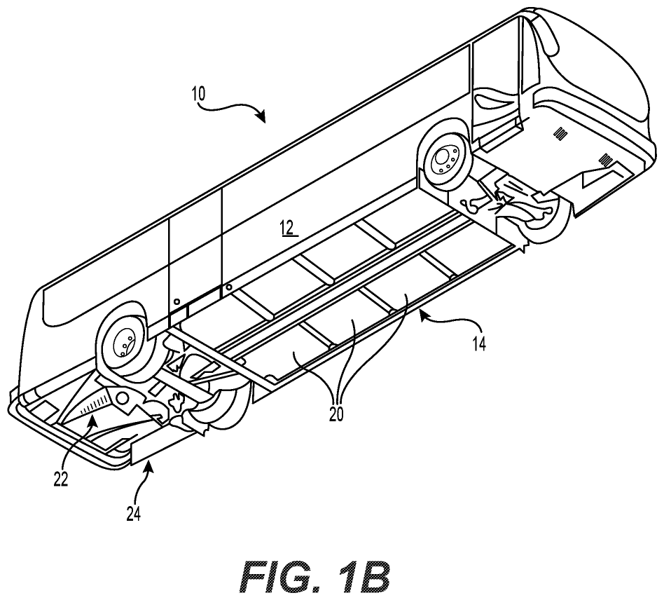

FIGS. 1A and 1B illustrate an electric vehicle in the form of a bus 10. FIG. 1A shows the bus 10 with its roof visible, and FIG. 1B shows the bus 10 with its undercarriage visible. In the discussion below, reference will be made to both FIGS. 1A and 1B. The bus 10 may include a body 12 enclosing a space for passengers. In some embodiments, some (or substantially all) parts of the body 12 may be fabricated using one or more composite materials to reduce the weight of the bus 10. Without limitation, the body 12 of the bus 10 may have any size, shape, and configuration. In some embodiments, the bus 10 may be a low-floor electric bus. In a low-floor electric bus, there may be no stairs at the front and/or the back doors of the bus 10. In such a bus 10, the floor may be positioned close to the road surface to ease entry and exit into the bus 10. In some embodiments, the floor height of the low-floor bus may be about 30-45 centimeters from the road surface. In this disclosure, the term “about” is used to indicate a possible variation of ±10% in a stated numeric value, however embodiments described herein are not limited to such variation.

The bus 10 may include a powertrain 24 that propels the bus 10 along a road surface. The powertrain 24 may include one or more electric motors 22 that generate power, and a transmission that transmits the power to a pair of drive wheels (e.g., wheels 18) of the bus 10. A battery system 14 may store electrical energy to power the electric motors 22 of the powertrain 24. In some embodiments, the batteries of the battery system 14 may be configured as a plurality of battery packs 20 positioned in cavities located under the floor of the bus 10. In some embodiments, some or all of the battery packs 20 may be positioned elsewhere (e.g., roof) on the bus 10. The batteries of the battery system 14 may have any chemistry and construction. The battery chemistry and construction may activate fast charging of the batteries. In some embodiments, the batteries may be lithium titanate oxide (LTO) batteries. In some embodiments, the batteries may be nickel metal cobalt oxide (NMC) batteries. It is also contemplated that, in some embodiments, the batteries may include multiple different chemistries.

The bus 10 may include a charging interface. For example, the bus 10 may include a charge port (e.g., an electric socket) that is configured to receive a charging plug and charge the bus 10 using power from a utility grid. In such embodiments, the bus 10 may be charged by connecting the plug to the socket. In some embodiments, the charge port may be a standardized charge port (e.g., a Society of Automotive Engineers (SAE) J1772 charge port) that is configured to receive a corresponding standardized connector (e.g., a SAE J1772 connector). However, in general, the charge port and the mating connector may be of any type and form (custom design or standardized). As illustrated in FIG. 1A, to protect the charge port from the environment (rain, snow, debris, etc.), a hinged lid 16 may cover the charge port when not in use. Additionally, or alternatively, a charging interface may be provided on the roof of the bus 10 (not illustrated in FIGS. 1A and 1B) to charge the batteries of the battery system 14. For example, the charging interface may include components that interface with a charging head (e.g., an inverted pantograph that interfaces with a set of rails mounted on the forward rooftop of the bus 10) of an external charging station to charge the batteries.

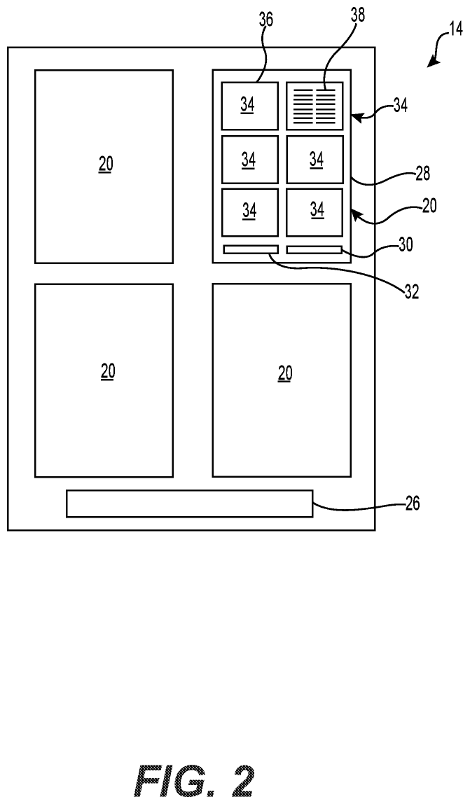

FIG. 2 is a schematic illustration of an exemplary battery system 14 of the bus 10 of FIGS. 1A and 1B, according to the present disclosure. The battery system 14 may include a plurality of battery packs 20. Each battery pack 20 may include a plurality of battery modules 34, and each battery module 34 may include a plurality of battery cells 38 arranged therein. In FIG. 2, the inside structure of one of the battery packs 20, and the inside structure of one of the battery modules 34 of the battery pack 20, are shown to aid in the discussion below. The battery cells 38 may have any chemistry and construction. In some embodiments, the battery cells 38 may have a lithium-ion chemistry. Lithium-ion chemistry comprises a family of battery chemistries that employ various combinations of anode and cathode materials. In automotive applications, these chemistries may include lithium-nickel-cobalt-aluminum (NCA), lithium-nickel-manganese-cobalt (NMC), lithium-manganese-spinel (LMO), lithium titanate (LTO), and lithium-iron phosphate (LFP), for example. In consumer applications, the battery chemistry may also include lithium-cobalt oxide (LCO), for example.

The plurality of battery packs 20 of the battery system 14 may be connected together in series or in parallel. In some embodiments, these battery packs 20 may also be arranged in strings. For example, the battery system 14 may include multiple strings connected in parallel, with each string including multiple battery packs 20 connected together in series. Configuring the battery system 14 as parallel-connected strings may allow the bus 10 to continue operating with one or more strings disconnected if a battery pack 20 in a string fails or experiences a problem. The plurality of battery modules 34 in each battery pack 20, and the plurality of battery cells 38 in each battery module 34, may also be electrically connected together in series or parallel. In some embodiments, some of the battery modules 34 in a battery pack 20 may be connected together in series, and groups of the series-connected battery modules 34 connected together in parallel. Similarly, in some embodiments, a group of battery cells 38 in each battery module 34 may be connected together in series to form multiple series-connected groups of battery cells 38, and these series-connected groups may be connected together in parallel. That is, some or all battery packs 20 in the battery system 14 may include both series-connected and parallel-connected battery modules 34, and some or all battery modules 34 in each battery pack 20 may include both series-connected and parallel-connected battery cells 38. In some embodiments, each battery pack 20 of the battery system 14 may be substantially identical (in terms of number of battery modules 34, number of battery cells 38 in each battery module 34, how the battery modules 34 are connected, etc.) to each other. In other embodiments, one or more of the battery packs 20 of the battery system 14 may have a different configuration than one or more other battery packs 20 of the battery system 14.

In general, the battery packs 20 of the battery system 14 may be physically arranged in any manner. In some embodiments, the battery packs 20 may be arranged in a single layer on a common horizontal plane to decrease the height of the battery system 14, so that it may be positioned under the floor of the low-floor bus 10. For example, the battery packs 20 may have a height less than or equal to about 18 centimeters, to allow the battery system 14 to be accommodated under the floor of the low-floor bus 10. The low height profile of the battery system 14 may allow the battery system 14 to be more aerodynamic, and may increase its surface area relative to the number of battery cells 38, which may increase heat dissipation and improve temperature regulation. In general, the battery system 14 may be configured to store any amount of energy and to export or import electrical power (in terms of Watts (W)) at a voltage (V). Increasing the amount of energy stored in the battery system 14 may increase the distance that the bus 10 can travel between recharges. In some embodiments, the number of the battery packs 20, the battery modules 34, the battery cells 38, and the chemistry of the battery cells 38, etc. may be configured such that the total energy capacity of the battery system 14 may be between, for example, about 200-700 kilowatt hours (KWh).

In general, the battery system 14 may have any number (e.g., 1, 2, 3, 4, 6, 8, 10, etc.) of battery packs 20. In some embodiments, the number of battery packs 20 in the battery system 14 may be between about 2 and 6. Each battery pack 20 may have a protective housing 28 that encloses the plurality of battery modules 34 (and other components of the battery pack 20) therein. Although the battery pack 20 of FIG. 2 is illustrated as including six battery modules 34 arranged in two columns, this is merely an example. In general, any number (e.g., 1, 4, 5, 6, 8, 10, 12, 14, 16, 18, 20, 22, 24, etc.) of battery modules 34 may be provided in a battery pack 20, and each battery module 34 may include any number of battery cells 38 (e.g., 1, 100, 101, 200, 300, 400, 500, 600, 800, etc.) arranged in any manner. In some embodiments, the number of battery modules 34 in each battery pack 20 may be between about 10 and 20, and the number of battery cells 38 housed in each battery module 34 may be between about 400 and 700. In some embodiments, the battery modules 34 housed in the housing 28 of a battery pack 20 may be separated from each other with dividers (not shown) that provide electrical and thermal insulation. The dividers may protect the other battery modules 34 if any battery module 34 fails (e.g., experiences a high temperature event). The dividers may be made of a material that does not oxidize or otherwise become damaged when exposed to electrical arcs and/or high temperatures.

The housing 28 of each battery pack 20 may have a box-like structure, and may be shaped to allow the battery modules 34 of the battery pack 20 to be arranged in a single layer on a common horizontal plane to decrease the height of the battery pack 20. In some embodiments, the housing 28 may be watertight (e.g., to about 1 meter) and may have a rating for dust and water resistance (e.g., an International Protection (IP) 67 rating). The housing 28 may be configured to contain any failures (e.g., electric arcs, fires, etc.) within the battery pack 20 in order to prevent damage to other battery packs 20 or other portions of the bus 10 if a component inside a battery pack 20 fails. In some embodiments, the housing 28 may be constructed of corrosion and puncture resistant materials. For example, the materials of which the housing 28 may be constructed may include composite materials, Kevlar, stainless steel, aluminum, high strength plastics, etc.

In addition to the battery modules 34, the housing 28 may also enclose a battery management system (BMS) 30 that monitors or controls the operation of the battery modules 34 and a thermal management system 32 that assists in managing the temperature of the battery modules 34 of the battery pack 20 (i.e., heat, cool, etc.). As described in more detail elsewhere herein, the BMS 30 and/or one or more other pack controllers may monitor the state (e.g., humidity, state of charge (SOC), current, temperature, etc.) of the battery modules 34 and the battery cells 38 in the battery pack 20, and may control the operations of the battery pack 20 to ensure that power is safely and efficiently directed into and out of the battery pack 20. The thermal management system 32 may include components that circulate air and/or a liquid coolant to the battery modules 34 to heat or cool the battery modules 34. These components may include, for example, circulating fans, coolant conduits, heat exchangers, etc. that assist in circulating air and/or a coolant through the battery modules 34 packaged in the housing 28 to manage the temperature of the battery pack 20.

The battery system 14 may include an energy storage management (ESM) system 26 that communicates with the BMS 30 included in the battery pack 20 to control the operation of the battery system 14 on a per-battery pack 20 basis. The ESM system 26 may include circuit boards, electronic components, sensors, and controllers that monitor the performance of the components (e.g., the battery packs 20, the battery modules 34, and the battery cells 38) of the battery system 14 based on sensor input (e.g., voltage, current, temperature, humidity, etc.), provide feedback (e.g., alarms, alerts, etc.), and control the operation of the battery system 14 for safe and efficient operation of the bus 10. In some embodiments, the ESM system 26 may perform charge balancing between different battery packs 20, battery modules 34 and/or battery cells 38 during recharging or during operation of the bus 10. The ESM system 26 may also thermally and/or electrically isolate sections (e.g., battery cells 38, battery modules 34, battery packs 20, etc.) of the battery system 14 when one or more sensor readings (e.g., temperature, etc.) exceed a threshold value. As will be described in more detail elsewhere herein, in some embodiments, the ESM system 26 may initiate or control energy discharge from all or selected battery packs 20, battery modules 34, or battery cells 38 based on the occurrence of predefined trigger events.

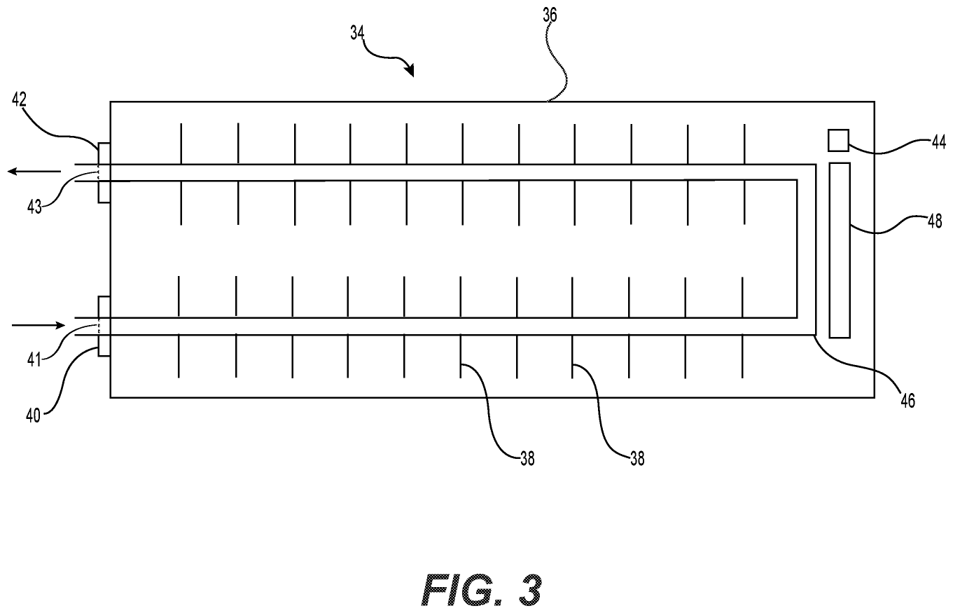

FIG. 3 is a schematic illustration of an exemplary battery module 34 of the battery system 14 of FIG. 2, according to the present disclosure. The battery module 34 includes a casing 36 that encloses the plurality of battery cells 38 of the battery module 34 therein. Similar to the housing 28 of the battery pack 20, the casing 36 may be configured to contain any failures (e.g., electric arcs, fires, etc.) of the battery cells 38 of the battery module 34 within the casing 36 in order to prevent the damage from spreading to other battery modules 34 of the battery pack 20. The casing 36 may be made of any material suitable for this purpose. In some embodiments, the casing 36 may be constructed of one or more of materials such as, for example, Kevlar, aluminum, stainless steel, composite materials, etc. In some embodiments, the casing 36 may be substantially air-tight to hermetically seal the battery cells 38 of the battery module 34 therein.

In general, the battery cells 38 may have any shape and structure (e.g., a cylindrical cell, a prismatic cell, a pouch cell, etc.). Typically, all the battery cells 38 of a battery module 34 may have the same shape. However, it is also contemplated that different shaped battery cells 38 may be packed together in the casing 36 of a battery module 34. In addition to the battery cells 38, the casing 36 may also include sensors (e.g., a temperature sensor, a voltage sensor, a humidity sensor, etc.) and controllers (e.g., a battery module controller 44) that monitor and control the operation of the battery cells 38. Although not illustrated, the casing 36 also may include electrical circuits (e.g., voltage and current sense lines, low voltage lines, high voltage lines, etc.), and related accessories (e.g., fuses, switches, etc.), that direct electrical current to and from the battery cells 38 during recharging and discharging.

As explained previously, the battery cells 38 of the battery module 34 may be electrically connected together in any manner (e.g., in parallel, in series, or in groups of series-connected battery cells 38 connected together in parallel). These battery cells 38 may also be physically arranged in any manner. In some embodiments, the battery cells 38 of a battery module 34 may be packed together tightly to fill the available volume within the casing 36. In some embodiments, the battery cells 38 may be arranged together to form multiple groups (e.g., bricks) of battery cells 38 electrically connected together in series. The multiple bricks (each comprising multiple battery cells 38 electrically connected together) may then be electrically connected together (e.g., in series or parallel) and packaged together in the casing 36. In some embodiments, one or more sensors may be associated with each brick of the battery module 34. Terminals (e.g., positive and negative terminals) electrically connected to the battery cells 38 of the battery module 34 may be provided on an external surface of the casing 36.

The casing 36 may also include a coolant loop 46 configured to circulate a coolant through the battery module 34. The coolant loop 46 may comprise fluid conduits arranged to pass through, or meander (e.g., zigzag) through, the volume enclosed by the casing 36. An inlet port 40 and an outlet port 42 of the casing 36 may fluidly couple the coolant loop 46 to a coolant circuit of the battery system 14. The coolant may enter the coolant loop 46 through the inlet port 40 and may exit the casing 36 through the outlet port 42. In some embodiments, where the battery module 34 is air cooled, the casing 36 may also include inlet and outlet vents configured to direct cooling air into and out of the casing 36. In some embodiments, the coolant may cool all the battery modules 34 of a battery pack 20 before exiting the battery pack 20. That is, the coolant loops 46 of the battery modules 34 of the battery pack 20 may be connected in series such that the coolant exiting one battery module 34 enters the coolant loop 46 of another battery module 34. In some embodiments, coolant may be directed into each battery module 34 individually (for e.g., from a common coolant gallery of the battery pack 20). In some embodiments, groups of battery modules 34 within a battery pack 20 may be fluidly connected in series and multiple series-connected battery modules 34 may be connected together in parallel.

During operation of the battery system 14, the battery cells 38 of the battery module 34 release heat. This released heat may be transferred to the coolant circulating through the coolant loop 46 and then removed from the casing 36 along with the coolant. In general, any known fluid may be used as the coolant. In some embodiments, water (with suitable additives such as antifreeze, etc.) or another suitable liquid may be used as the coolant. The battery cells 38 of the battery module 34 may be arranged to enhance heat dissipation into the coolant circulating through the battery module 34. For example, in some embodiments, the battery cells 38 may be in close thermal contact with the coolant loop 46. In some embodiments, the battery cells 38 may be placed in close thermal contact with metal plates that serve as heat conducting pathways to the coolant loop 46.

The battery module 34 may also include one or more heaters 48 positioned within the casing 36 (or in close thermal contact with the casing 36). In general, any type of heating device (e.g., a resistance heater, a positive temperature coefficient (PTC) heater, etc.) may be used as the heater 48. In some embodiments, the heater 48 may be a PTC cartridge heater. Unlike a resistance heater which generates heat at a constant rate, a PTC heater may use PTC resistive elements which generate heat at a lower rate at higher temperatures. Therefore, a PTC heater is self-regulating to a fixed working temperature

In some embodiments, the heater 48 (or the multiple heaters 48) of each battery module 34 may be powered solely by the battery cells 38 of that battery module 34. The heater 48 may be activated by the battery module controller 44 and/or by another controller (e.g., the ESM system 26, the BMS 30, etc.) of the battery system 14. When the heater 48 is activated, it generates heat using the energy stored in the battery cells 38 of that battery module 34. Consequently, the stored energy (or SOC) of the battery cells 38 in the battery module 34 decrease as a result of activation of the heater 48. The heat dissipated by the heater 48 may be removed from the battery module 34 by the circulating coolant (or by conduction). A temperature sensor (or thermistor) of the battery module 34 may monitor the heat dissipated by the heater 48.

The heater 48 may be positioned at any location within the casing 36. In general, the location of the heater 48 may be selected such that the maximum energy discharged by the heater 48 does not damage (or jeopardize the safety of) the battery cells 38 of the battery module 34. Therefore, in some embodiments, the heater 48 may be spaced away from (i.e., not directly in contact with) the battery cells 38 such that the heater 48 is thermally isolated from the battery cells 38. The location of the heater 48 may also be selected such that the dissipated heat can be easily transferred to the body of the battery pack 20 (thus allowing the heater 48 to dissipate more heat without a resulting increase in temperature). Therefore, in some embodiments, the heater 48 may be positioned in direct contact with the metal frame of the battery pack 20 to enhance heat conduction. In some embodiments, the heater 48 may be positioned close to (as illustrated in FIG. 3) the coolant loop 46 of the battery module 34 so that the dissipated heat may be easily transferred to the coolant circulating through the coolant loop 46. It is also contemplated that, in some embodiments, the heater 48 may be positioned within the coolant loop 46 (i.e., submerged in the coolant of the coolant loop 46). In some embodiments, as illustrated in FIG. 3, the heater 48 may be positioned about midway of the coolant loop 46 in the battery module 34. That is, the heater 48 may be positioned proximate to (on within) the coolant loop 46, and substantially equidistant from the inlet port 40 and the outlet port 42.

Although a single heater 48 is illustrated in FIG. 3, in some embodiments, multiple heaters (similar to the heater 48) may be positioned within the casing 36 of each battery module 34. Each of these multiple heaters 48 may be powered by the battery cells 38 of that battery module 34 so that activating these multiple heaters 48 may discharge energy from all the battery cells 38 at a faster rate as compared to a case when a single heater 48 is used. In some embodiments, a first group of battery cells 38 of the battery module 34 (e.g., a brick) may power a first heater 48, and a second group of battery cells 38 of the battery module 34 may power a second heater 48. In such an embodiment, activating the first heater 48 may selectively discharge energy from the first group of battery cells 38, and activating the second heater 48 may selectively discharge energy from the second group of battery cells 38. The multiple heaters 48 may be positioned adjacent to each other or spaced apart from each other in the casing 36. In some embodiments, the multiple heaters 48 may be positioned such that desired regions of the battery module 34 can be selectively discharged by activating different heaters 48.

As explained previously, the heater 48 may be activated by the BMS 30 alone or in cooperation with the battery module controller 44 and/or the ESM system 26. In some embodiments, the BMS 30 may simultaneously activate the heaters 48 embedded in (inserted in, positioned in, included in, etc.) each battery module 34 of the battery system 14 to discharge energy from the battery cells 38 of every battery module 34, and thereby, reduce the SOC of the entire battery system 14. In some embodiments, the BMS 30 may selectively activate the heaters 48 embedded in selected battery modules 34 to preferentially discharge energy from (and thereby reduce the SOC of) the selected battery modules 34. For example, if sensors detect that one battery module 34 of a battery pack 20 includes a damaged battery cell 38, the BMS 30 may selectively activate the heaters 48 embedded in all the other battery modules 34 of the battery pack 20 (i.e., except the battery module 34 with the damaged battery cell 38) to safely decrease the SOC of the battery pack 20. In embodiments where multiple heaters 48 are embedded in a battery module 34, the BMS 30 may also be configured to selectively activate some heaters 48 of the battery module 34 to preferentially discharge energy from selected battery cells 38 (e.g., bricks) of the battery module 34.

The BMS 30 may activate the heaters 48 embedded in the battery modules 34 to discharge energy from (and thus decrease the SOC of) the battery system 14 of a stranded (or otherwise incapacitated) bus 10 before service personnel operate on (repair, remove the batteries from, etc.) the bus 10. The battery system 14 of the bus 10 may store a relatively large amount of energy (e.g., between about 200-700 KWh). Operating on a bus 10 with such a large amount of stored energy may be undesirable. Dissipating the stored energy from the battery system 14 by activating the heaters 48 lowers the SOC of the battery system 14. After the SOC of the battery system 14 has been lowered to a suitable level, the heaters 48 may be deactivated. Although the discussion above describes embedding a heater 48 in a battery module 34 of a battery pack 20, this is merely exemplary. In general, any electric load may be embedded in a battery module 34 to selectively dissipate energy from the battery cells 38 of the battery module 34

In general, the heat produced by the heaters 48 may be dissipated from the battery system 14 by conduction, convection, or radiation. The heaters 48 may be positioned in the battery modules 34 such that the heat produced by them can be removed without overheating the battery cells 38 of the battery module 34. In some embodiments, the heat produced by the heaters 48 of a battery module 34 may be used to increase the temperature of the battery cells 38 of the battery module 34. In some embodiments, the inlet port 40 and/or the outlet port 42 of the coolant loop 46 may be selectively opened and closed (e.g., using adjustable valves 41 and 43 shown by the dashed lines in FIG. 3) by the BMS 30, based on sensor readings (e.g., humidity, temperature, etc.) from within the battery module 34. The BMS 30 may use these adjustable valves to redirect the coolant flow within the battery system 14 based on the local conditions within the battery modules 34.

The implementation of a heater 48 in every battery module 34 of the battery system 14 (as opposed to providing a coolant heater external to the battery system 14) may activate the battery cells 38 of the battery system 14 to be heated more quickly and efficiently. Further, locating the heater 48 to be substantially in the middle of the coolant loop 46 may activate the heat dissipated by the heater 48 to be distributed throughout the coolant loop 46 which may result in improved heating performance in a short amount of time.

The BMS 30 (and/or other controllers of the battery system 14) may selectively activate the heaters 48 of a battery module 34 in response to any triggering event. In some embodiments, the triggering event may include input from a human operator or one or more sensors of the bus 10. In response to the triggering signal, the BMS 30 may selectively activate one or more of the heaters 48 embedded in selected battery modules 34 (i.e., all or some of the battery modules 34).

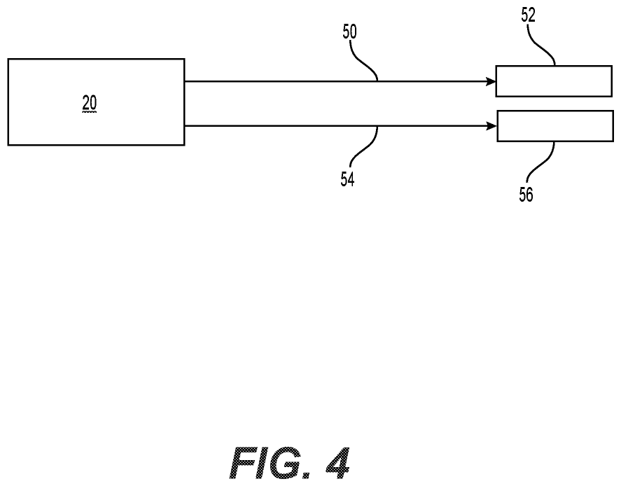

FIG. 4 is a schematic illustration of connections between the battery pack 20 of FIG. 2 and peripheral devices or systems of the bus 10 of FIGS. 1A and 1B, according to the present disclosure. As illustrated, the schematic in FIG. 4 includes the battery pack 20, a high voltage bus bar 50, a high voltage peripheral device or system 52, a low voltage bus bar 54, and a low voltage peripheral device or system 56. The battery pack 20 may be electrically connected (e.g., through one or more electrical terminals 62, 66 not illustrated in FIG. 4) to the high voltage bus bar 50. The high voltage bus bar 50 may provide one or more electrical connections between the battery pack 20 and the high voltage peripheral device or system 52 for carrying high voltage power (e.g., at greater than or equal to approximately 100 V) from the battery pack 20 to the high voltage peripheral device or system 52. The high voltage peripheral device or system 52 may include, for example, devices or systems of the bus 10 used during operation of the bus 10, such as the powertrain 24, an heating, ventilation, and air conditioning (HVAC) system, an external DC/DC system, or the like.

Similarly, the battery pack 20 may be electrically connected to the low voltage bus bar 54. The low voltage bus bar 54 may provide one or more electrical connections between the battery pack 20 and the low voltage peripheral device or system 56 for carrying low voltage power (e.g., at less than 100 V) from the battery pack 20 to the low voltage peripheral device or system 56. The low voltage device or system 56 may include, for example, devices or systems that are operational when the bus 10 is not in use or is in an idle state, such as a fire suppression system, a security system, a lighting system, an indicator, a cooling pump, or the like. In some implementations, the low voltage device or system 56 may include any device or system of the bus 10 that does not operate on a high voltage energy storage system.

Although FIG. 4 illustrates a single battery pack 20, there may be multiple battery packs 20 electrically connected to the high voltage bus bar 50 or the low voltage bus bar 54, and the multiple battery packs 20 may be organized into electrically parallel strings of battery packs 20 (with the battery packs 20 included in a string connected in series). In addition, the illustration of a single high voltage peripheral device or system 52 and a single low voltage peripheral device or system 56 is merely exemplary and some embodiments may include multiple high voltage peripheral devices or systems 52 and/or multiple low voltage peripheral devices or systems 56.

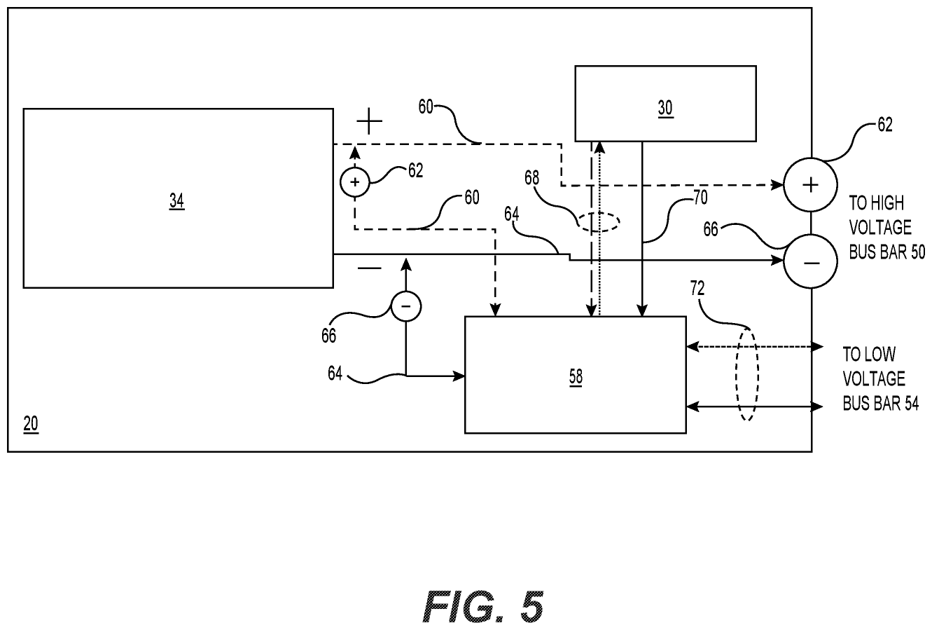

FIG. 5 is a schematic illustration of a battery pack 20 of the battery system 14 of FIG. 2 that includes a DC/DC converter 58, according to the present disclosure. The schematic illustrated in FIG. 5 includes, a battery pack 20, a BMS 30, a battery module 34, a high voltage bus bar 50, a low voltage bus bar 54, a DC/DC converter 58, positive electrical connections 60, positive electrical terminals 62, negative electrical connections 64, negative electrical terminals 66, software layer communication lines 68, a hardware layer communication line 70, and electrical connections 72.

The DC/DC converter 58 may include one or more electrical circuits or electromechanical devices that receives an input of a direct current of electrical power at one voltage and outputs a direct current of electrical power at another voltage (a higher or lower voltage than the input voltage). For example, the DC/DC converter 58 may perform such a conversion by storing the input power (e.g., using magnetic field storage components, such as inductors or transformers, or using electric field storage components, such as capacitors) and then releasing the power to the output of the DC/DC converter 58.

As illustrated in FIG. 5, the DC/DC converter 58 may be electrically connected to the battery module 34 via a positive electrical terminal 62 and a negative electrical terminal 66, which may be separate components from the DC/DC converter 58, and thus separately controllable (e.g., control of on/off states) from the DC/DC converter 58. For example, the DC/DC converter 58 may be directly connected to a high voltage DC bus bar included in the battery pack 20. In addition, the DC/DC converter 58 may be electrically connected to the low voltage bus bar 54 via the electrical connections 72 (e.g., separate positive and negative electrical connections). The DC/DC converter 58 may include one or more relays and fuses for protection from the high voltage connections to the battery module 34 (e.g., the electrical connections 60 and 64 via the electrical terminals 62 and 66) and one or more fuses for protection from the low voltage connections to the low voltage bus bar 54 (e.g., the electrical connections 72).

In some embodiments, the DC/DC converter 58 may be located in an ancillary bay of the battery pack 20. Additionally, or alternatively, the DC/DC converter 58 may be included in the coolant system of the battery pack 20. For example, the DC/DC converter 58 may have one or more mechanical connections to the coolant loop 46. This may reduce or eliminate a need for a DC/DC converter 58 external to the battery pack 20 or for independent cooling channels, heat sinks, or fans for cooling the DC/DC converter 58.

The DC/DC converter 58 may be bidirectional. For example, the DC/DC converter 58 may receive electrical power from the low voltage bus bar 54, may increase the voltage of the electrical power, and may then output the electrical power to the battery module 34. Alternatively, the DC/DC converter 58 may receive electrical power from the battery module 34, may decrease the voltage of the electrical power, and may then output the electrical power to the low voltage bus bar 54. As a specific example, the DC/DC converter 58 may receive an input of about 330 Vdc power and may output about 24-28 Vdc power, or vice versa.

The amount of power available to the bus 10 via the DC/DC converter 58 may be based on the output power of the DC/DC converter 58 and the quantity of DC/DC converters 58 (e.g., power may equal converter power multiplied by converter quantity). For example, the amount of power available to the bus 10 may be equal to the quantity of DC/DC converters 58 times the wattage of the DC/DC converter 58. As a specific example, if the bus 10 includes four battery packs 20 with a 500 W DC/DC converter 58 per battery pack 20, there may be about 2 kilowatts (kW) of DC power available to the bus 10 without an externally connected DC/DC converter. If the bus 10 includes a lower quantity of battery packs 20, e.g., two battery packs 20, the battery packs 20 may include higher output power DC/DC converters 58 or may provide the bus 10 with less than approximately 2 kW of power.

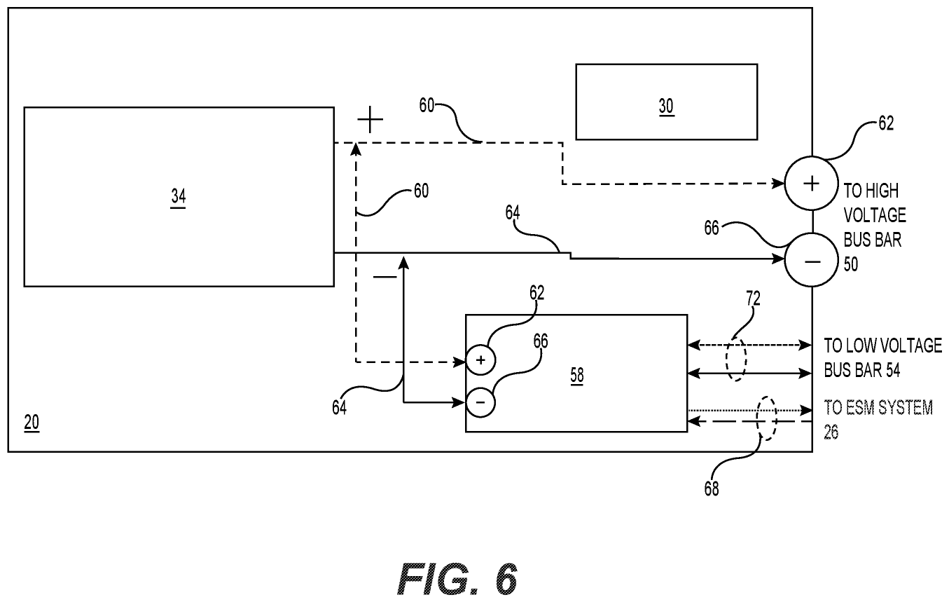

The software layer communication lines 68 may include wired or wireless connections for bidirectional communication between the DC/DC converter 58 and the BMS 30. For example, the software layer communication lines 68 may include a controller area network (CAN) bus, a serial communication line, and/or the like. As described in more detail elsewhere herein, the BMS 30 may send instructions to the DC/DC converter 58 to configure the DC/DC converter 58 to operate in a particular manner and/or may receive data related to the operation of the DC/DC converter 58 via the software layer communication lines 68. The hardware communication line 70 may include an electrical connection for logic and/or voltage signaling from the BMS 30 to the DC/DC converter 58, or vice versa. As described in more detail elsewhere herein, the BMS 30 may provide enabling/disabling signaling to the DC/DC converter 58 via the hardware communication line 70. The software layer communication lines 68 and/or the hardware communication lines 70 may form a communication bus bar and the BMS 30 may be controlled by the ESM system 26 (see FIG. 6).

The battery pack 20 may include one or more additional components not illustrated in FIG. 5 (or elsewhere herein). For example, the battery pack 20 may include a high voltage interlock loop (HVIL), which may be configured to protect people from electrical power stored in the battery pack 20 during maintenance, assembly, etc. In some embodiments, the BMS 30 may activate or deactivate the HVIL, such as when the bus 10 is in a maintenance facility. In some embodiments, an activate signal for enabling the DC/DC converter 58 via the software layer communication lines 68 and/or the hardware layer communication line 70 may be part of the enabling signal for the HVIL. For example, when the DC/DC converter 58 is activated to import power to or export power from a battery pack 20, low voltage DC terminal pins for the bus 10 may be deactivated for safety.

FIG. 6 is another schematic illustration of a battery pack 20 of the battery system 14 of FIG. 2 that includes a DC/DC converter 58, according to the present disclosure. The battery pack 20 illustrated in FIG. 6 may include some of the same components as the battery pack 20 illustrated in FIG. 5. However, rather than being connected to the BMS 30 via the software layer communication lines 68 and the hardware layer communication line 70, the DC/DC converter 58 of FIG. 6 may be connected directly to the ESM system 26 (not illustrated in FIG. 6) via the software layer communication lines 68. Thus, in some embodiments, the ESM system 26, rather than the BMS 30, may directly control the operation of the DC/DC converter 58.

In some embodiments, a positive electrical terminal 62 and a negative electrical terminal 66 may be included in the DC/DC converter 58 and may be controlled in conjunction with the DC/DC converter 58. For example, the positive electrical terminal 62 and the negative electrical terminal 66 may be controlled by the same enabling/disabling signals as the DC/DC converter 58 and/or may be controlled directly by the DC/DC converter 58 based on signaling received from the ESM system 26. Although the schematics of FIGS. 5 and 6 have been described separately, the schematics may be combined in some embodiments. For example, the battery pack 20 of FIG. 5 may be modified in some embodiments such that the DC/DC converter 58 is directly connected to the ESM system 26, as in the schematic of FIG. 6.

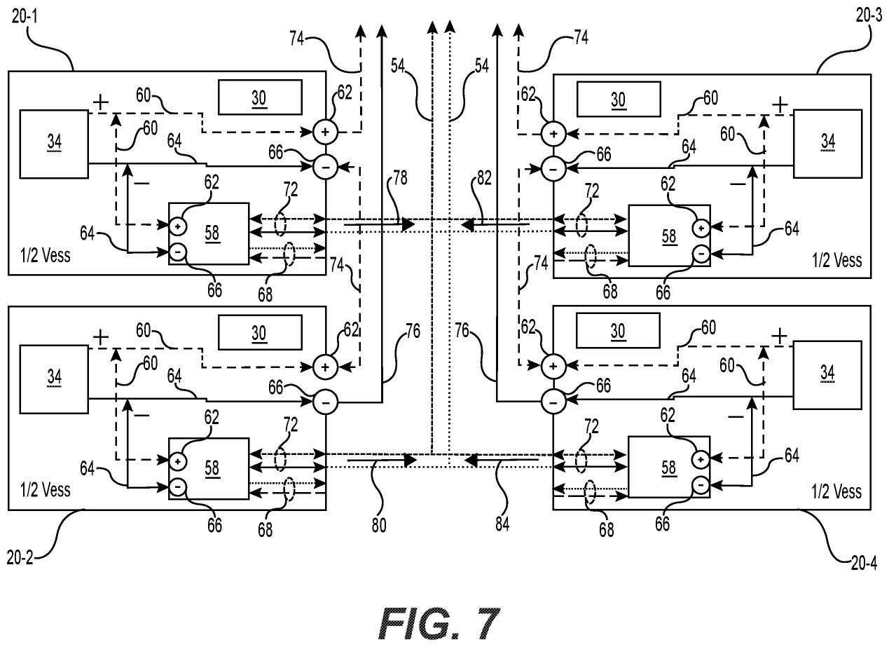

FIG. 7 is a schematic illustration of power export from battery packs 20 of FIG. 6 with balanced stored energy levels, according to the present disclosure. As illustrated, the schematic in FIG. 7 includes, for example, 4 battery packs 20 (battery pack 20-1, battery pack 20-2, battery pack 20-3, and battery pack 20-4) similar to the battery pack 20 illustrated in FIG. 6. The battery packs 20-1 and 20-2 may form a first string of battery packs 20 and may be electrically connected in series with each other via corresponding positive electrical connections 74 and negative electrical connections 76 (where electrical connections 74 and 76 may form the high voltage bus bar 50). The battery packs 20-3 and 20-4 may form a second string of battery packs 20 and may be electrically connected in series with each other via corresponding positive electrical connections 74 and negative electrical connections 76. The first string and the second string may be electrically connected in parallel with each other. As used herein, “Vess” is an acronym for voltage-energy storage system.

Assume for the example of FIG. 7 that the battery packs 20 have balanced energy storage (or about the same amount of energy storage). In this case, the DC/DC converters 58 may each be configured to export an equal amount of power at a target current from their respective battery modules 34 to the low voltage bus bar 54 on a per-string basis. For example, as illustrated by power flow paths 78 and 80, the DC/DC converters 58 of the battery packs 20-1 and 20-2 may each be configured to export half of the power output for the first string at half the target current for the first string (where “½ Vess” indicates that each high voltage battery 20-1 and 20-2 contributes half of the overall string voltage and that the two battery packs on the first string have balanced energy levels) and, as illustrated by power flow paths 82 and 84, the DC/DC converters 58 of the battery packs 20-3 and 20-4 may each be configured to export half of the power output for the second string at half the target current for the second string. As a specific example and without limitation, if each string of battery packs 20 have to output a maximum of 1000 watts (W) of power at 24 V, then the battery packs 20-1 and 20-2 may be each configured to export 500 W of power at 24 V to the low voltage bus bar 54 and the battery packs 20-3 and 20-4 may be each configured to export 500 W of power at 24 V to the low voltage bus bar 54. In this way, the DC/DC converters 58 may be configured to evenly deplete battery packs 20 when the battery packs 20 have equal energy storage levels within and between each string of battery packs 20.

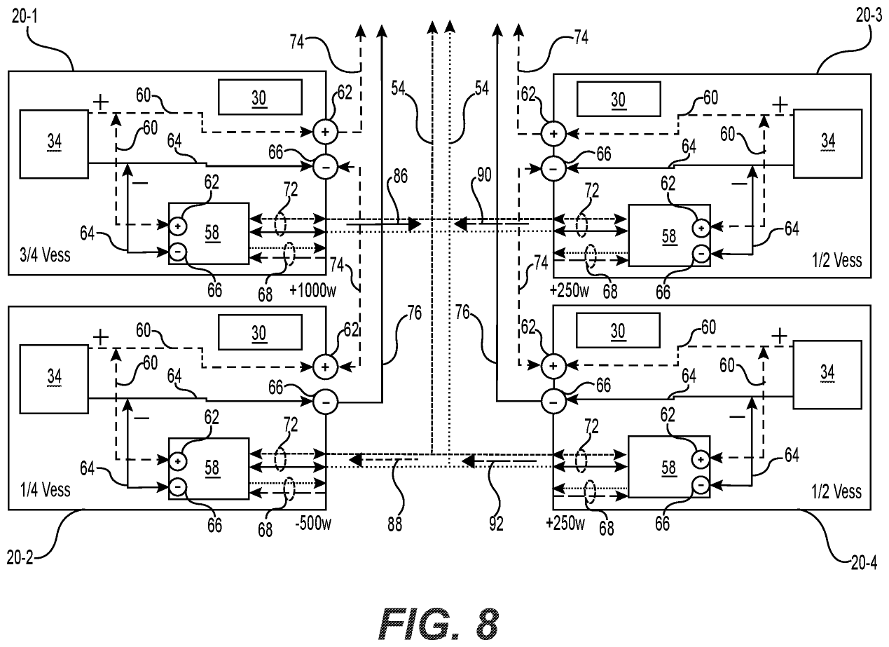

FIG. 8 is a schematic illustration of power import to, and power export from, battery packs 20 of FIG. 6 with imbalanced stored energy levels, according to the present disclosure. In contrast to the schematic illustrated in FIG. 7, assume for example that the battery packs 20 in the schematic illustrated in FIG. 8 do not store equal amounts of energy and represent different portions of a target current of a string of battery packs 20. In addition, assume for the example schematic illustration of FIG. 8 that different strings of battery packs 20 (e.g., a first string of battery packs 20 that includes battery packs 20-1 and 20-2 and a second string of battery packs 20 that includes battery packs 20-3 and 20-4) are capable of operating at a target voltage. In this case, some of the DC/DC converters 58 may be configured to export power (the same or different amounts of power), and some of the DC/DC converters 58 may be configured to import power. For example, as illustrated by power flow path 86, the battery pack 20-1 may be configured to export 1000 W (“+1000 W”) of power to the low voltage bus bar 54 for the first string of battery packs 20. As illustrated by power flow path 88, the battery pack 20-2 may be configured to import 500 W (“−500 W”) of power from the low voltage bus bar 54 for the first string of battery packs 20. The “¾ Vess” and the “¼ Vess” may indicate that the battery packs 20-1 and 20-2 contribute 75% and 25% of the string voltage, respectively, and that the battery packs 20-1 and 20-2 have imbalanced energy levels. As illustrated by power flow paths 90 and 92, the battery packs 20-3 and 20-4 may both be configured to export 250 W (“+250 W”) of power to the low voltage bus bar 54 each at 50 percent of the target current of the second string of battery packs 20. Thus, the first string of battery packs 20 (battery packs 20-1 and 20-2) and the second string of battery packs 20 (battery packs 20-3 and 20-4) may each export a net of 500 W of power at a target voltage while charging the battery pack 20-2. In addition, the battery packs 20-3 and 20-4 may contribute half of the voltage for the second string and may have balanced energy levels.

In this way, energy may be transferred from the higher charge level battery packs 20 (battery packs 20-1, 20-3, and 20-4) to the lowest charge level battery pack (battery pack 20-2), thus rebalancing the charge levels of the battery packs 20. Furthermore, this can advantageously reduce and/or eliminate a need to remove the bus 10 from service or deactivate a string of battery packs 20 of the bus 10 (e.g., the string of battery packs 20 that includes the lowest charge battery pack 20) while charge level imbalances are corrected.

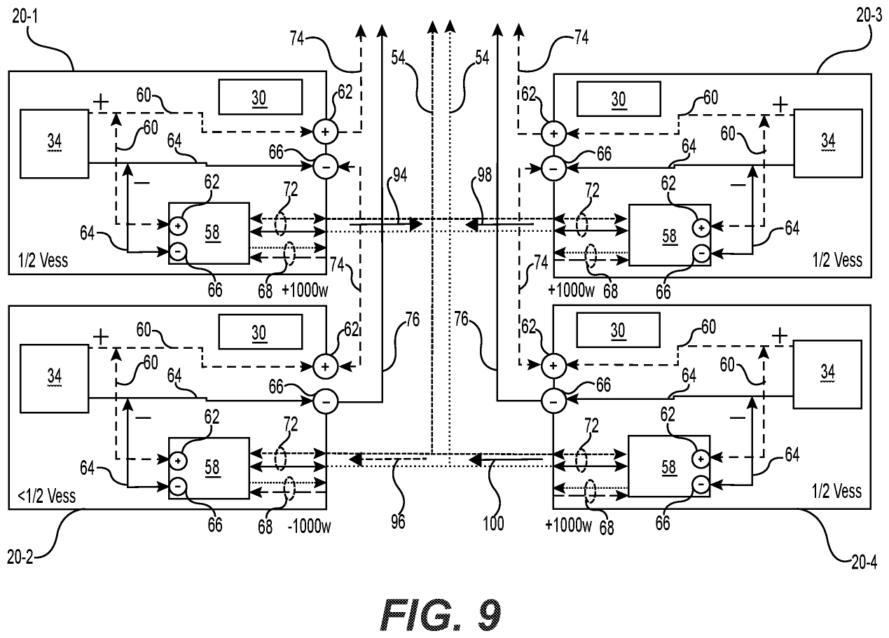

FIG. 9 is another schematic illustration of power import to, and power export from, battery packs 20 of FIG. 6 with imbalanced stored energy levels, according to the present disclosure. For example, in the schematic illustrated in FIG. 9, the battery pack 20-2 may have a very low state of charge (e.g., a 25 percent or less charge), such as due to being a replacement battery pack 20. In this case, the first string of battery packs 20 (battery packs 20-1 and 20-2) may be deactivated by the ESM 26 for high voltage use but, as illustrated by power flow path 94, the battery pack 20-1 may be configured by the ESM 26 to export power to the low voltage bus bar 54 (e.g., 1000 W export, shown as “+1000 W”). As illustrated by power flow path 96, the battery pack 20-2 may be configured to import power from the low voltage bus bar 54 (e.g., 1000 W import, shown as “−1000 W”). For the first string, the battery packs 20-1 and 20-2 may have imbalanced stored energy levels and the battery pack 20-2 may contribute less than half of the voltage for the first string (“<½ Vess”). In addition, as illustrated by power flow paths 98 and 100, the battery packs 20 of the second string (battery packs 20-3 and 20-4) may be each configured to export power to the low voltage bus bar 54 (e.g., 1000 W export each, shown as “+1000 W”). This configuration of power export and import may help to quickly charge the battery pack 20-2 from a state of very low charge without needing to connect the bus 10 to a charging port. Because the first string of battery packs 20 is deactivated in this example, there may not be a need to balance the net power output between the first string and the second string, in contrast to the example illustrated in FIG. 8, as the first string may not be able to affect operations of the high voltage bus bar 50 in a deactivated state.

In this way, power may be transferred from the battery packs 20-1, 20-3, and 20-4 to the battery pack 20-2 during operation of the bus 10 or while the bus 10 is in an idle state. Furthermore, this may result in rapid charging of the battery pack 20-2 because the first string of battery packs 20 is deactivated. In this configuration, battery packs 20-3 and 20-4 may supply all of the available low voltage power from the battery packs 20, while battery pack 20-1 may supply the imported energy for battery pack 20-2.

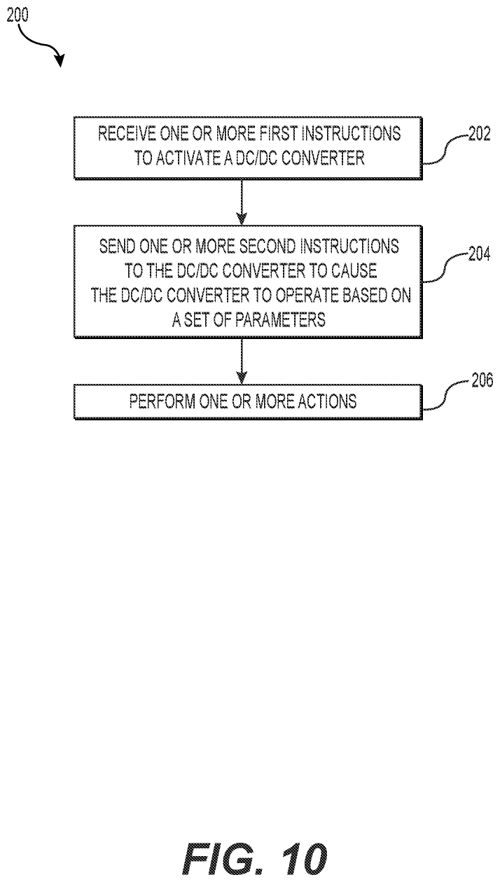

FIG. 10 illustrates an exemplary method 200 of enabling a DC/DC converter 58 included in a battery pack 20 of FIG. 6, according to the present disclosure. The method 200 may be performed by the BMS 30, the ESM system 26, and/or one or more other controllers associated with the battery system 14. The method 200 may include, at operation 202, receiving one or more first instructions to activate a DC/DC converter 58. For example, when the battery pack 20 is configured in the manner illustrated in FIG. 5, the BMS 30 may receive the one or more first instructions from another system associated with the bus 10 (e.g., the ESM system 26) based on the bus 10 being connected to a charging station, based on entering an idle state, or based on input from a control panel associated with the bus 10 or a maintenance facility. When the battery pack 20 is configured in the manner illustrated in FIG. 6, the ESM system 26 may receive the one or more first instructions to activate the DC/DC converter 58 from another system associated with the bus 10, such as a from a diagnostic system of the bus 10, or may determine to activate the DC/DC converter 58 based on detecting an imbalance of stored energy across multiple battery packs 20.

The method 200 may further include, at operation 204, sending one or more second instructions to the DC/DC converter 58 to cause the DC/DC converter 58 to operate based on a set of parameters. For example, the BMS 30 (when the battery pack 20 is configured as illustrated in FIG. 5) or the ESM system 26 (when the battery pack 20 is configured as illustrated in FIG. 6) may send the one or more second instructions via the software layer communication lines 68. Additionally, or alternatively, the BMS 30 and/or the ESM system 26 may send logic or voltage signaling via the hardware layer communication line 70 as the one or more second instructions, depending on the configuration of the battery pack 20. The set of parameters may include, for example, a direction of power flow (import or export) relative to the battery cells 38 of the battery pack 20, an operating voltage for the battery pack 20, an operating current for the battery pack 20, an amount of power to be imported to, or exported from, the battery pack 20 (e.g., a power limit), and/or the like.

Additionally, or alternatively, the set of parameters may include an indication of whether the battery pack 20 is to operate in a particular mode, such as a soft start mode or a low voltage battery charging mode. For example, a soft start mode may include a mode where the ESM system 26 sets a target voltage limit (e.g., approximately 28 V) and the DC/DC converter 58 increases the operating voltage from a starting voltage limit (e.g., approximately 24 V) to the target voltage limit over time rather than starting operation at the target voltage limit set by the ESM system 26. As another example, a low voltage battery charging mode may include a mode where the DC/DC converter 58 operates at a lower voltage. For example, the battery system may operate below a nominal voltage range (e.g., a 24V nominal system (a 24V-28V system) may start at 18V to account for a severely depleted low voltage battery). This operation mode may be needed if the power supplies for the DC/DC converter 58 are disabled, or if the standby load has exceeded their ability to supply the needed power and the balance was drawn from the low voltage battery pack 20.

In some embodiments, the method 200 may include sending control signaling for enabling and/or disabling various electrical contacts of the battery pack 20 (e.g., electrical contacts of terminals 62 or 66). The configuration of activated and deactivated electrical contacts may depend on whether the battery pack is to import power or export power. The control signaling may be included in the one or more second instructions, such as when the DC/DC converter 58 includes the electrical contacts, or as separate signaling, such as when the electrical contacts are separate components from the DC/DC converter 58.

The operation at 204 may be performed when the bus 10 is in an active (e.g., in operation on a route) or an idle state (e.g., powered off in a maintenance facility or storage yard). For example, the ESM system 26 may send the instructions to multiple DC/DC converters 58 for power import or export when a charge level imbalance is detected during operation of the bus 10, and the DC/DC converters 58 may operate according to the instructions at a later time when the bus 10 enters an idle state at a maintenance facility or storage yard. Additionally, or alternatively, the ESM system 26 may send the instructions after the bus 10 enters the idle state, such as during an idle state diagnostic test that checks the charge level of battery packs 20 of the bus 10.

The method 200 may further include, at operation 206, performing one or more actions. For example, after the DC/DC converter 58 has been operating for some amount of time according to the set of parameters sent in connection with the operations at 204, the method 200 may include sending one or more third instructions to deactivate the operation of the DC/DC converter 58, to modify the set of parameters, and/or the like. In addition, the method 200 may include, receiving, from the DC/DC converter 58, metrics related to the operation of the DC/DC converter 58 and sending the third instructions to modify the operation of the DC/DC converter 58 based on the received metrics (e.g., increase or decrease the operation, stop the operation, etc.). The metrics may include, for example, an operating voltage and/or current of the DC/DC converter 58, a charge level of the battery pack 20, an amount power import to or export from the battery pack 20, one or more fault indicators, and/or the like.

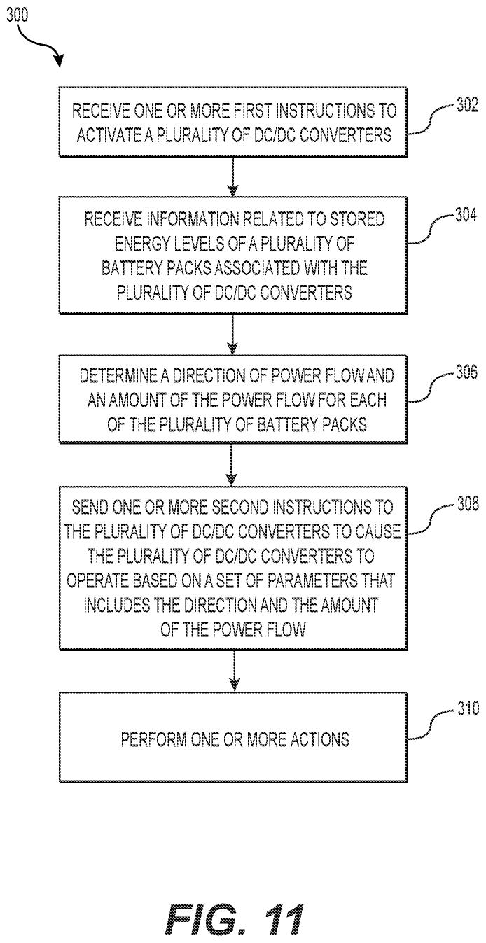

FIG. 11 illustrates an exemplary method 300 of balancing stored energy levels among multiple battery packs 20 of FIG. 6, according to the present disclosure. The method 300 may be performed by the ESM system 26, the BMS 30, and/or one or more other controllers associated with the battery system 14. The method 300 may include, at operation 302, receiving one or more first instructions to activate a plurality of DC/DC converters 58. For example, the ESM system 26 may receive the one or more first instructions from another system associated with the bus 10, based on the bus 10 being connected to a charging station, based on the bus 10 entering an idle state, or based on input from a control panel associated with the bus 10 or a maintenance facility. The method 300 may further include, at operation 304, receiving information related to stored energy levels of a plurality of battery packs 20 associated with the plurality of DC/DC converters 58. For example, the ESM system 26 may query the BMSs 30 in the battery packs 20 for information related to the stored energy levels of the battery packs 20, and the BMSs 30 may provide that information based on receiving the query. In some embodiments, the operations at 302 and 304 may be different. For example, the ESM system 26 may first query the BMSs 30 for the information related to the energy storage levels (similar to operation 304), and may then determine to activate the DC/DC converters 58, rather than receiving the first instructions at 302.

The method 300 may include, at operation 306, determining a direction of power flow and an amount of the power flow for each of the plurality of battery packs 20. For example, the ESM system 26 may determine the direction of power flow and the amount of the power flow based on the information received in connection with the operation at 304. The direction of power flow for each battery pack 20 may be determined based on whether a battery pack 20 has more or less stored energy relative to the other battery packs 20 and the power flow directions and amounts needed to balance stored energy among the battery packs 20 of the battery system 14. For example, the ESM system 26 may determine that a battery pack 20 is to export power to the low voltage bus bar 54 if that battery pack 20 has the most stored energy relative to other battery packs 20 in the battery system 14, has at least a threshold amount of stored energy, has more than the average stored energy among multiple battery packs 20, and/or the like. Conversely, the ESM system 26 may determine that a battery pack 20 is to import power from the low voltage bus bar 54 if the battery pack 20 has the least amount of stored energy relative to other battery packs 20 in the battery system 14, has less than a threshold amount of stored energy, has less than the average stored energy among multiple battery packs 20, and/or the like.

The ESM system 26 may determine the direction and amount of power flow for the battery packs 20 on a per-string basis. For example, the ESM system 26 may determine directions and amounts of power flow for each battery pack 20 of a string of battery packs 20 such that the direction and amount of an aggregate power flow for the string of battery packs 20 is equal to the direction and amount of an aggregate power flow for one or more other strings of battery packs 20, results in an aggregated direction and amount of power flow into a particular string of battery packs 20 and/or particular battery pack 20 of the string, and/or the like. In some embodiments, the directions and amounts of power flow may be the same or different for different battery packs 20 in the same string or in different strings. Additionally, or alternatively, the direction and amount of an aggregate power flow for a string of battery packs 20 may be the same as or different from another string of battery packs 20.

In some embodiments, the ESM system 26 may determine to activate or deactivate high voltage output of one or more strings of battery packs 20 and/or one or more battery packs 20 of a string in connection with determining the direction and amount of power flow for each of the battery packs 20. For example, the ESM system 26 may determine to deactivate a battery pack 20 or a string of battery packs 20 if a battery pack 20 is to import power from the low voltage bus bar 54 and if the amount of power to be imported satisfies a threshold (e.g., in the case where the battery pack 20 is a replacement battery pack with a very low factory-provided SOC, such as a 10 percent SOC).

In connection with the operation 306, the method 300 may include determining a configuration of activated electrical contacts and deactivated electrical contacts. For example, the ESM 26 may determine a first configuration of electrical contacts that allows for import of power to the battery pack 20 from the low voltage bus bar 54 or a second configuration of electrical contacts that allows for export of from the battery pack 20 to the low voltage bus bar 54. The method 300 may then include sending control signaling that indicates the determined configuration, such as in connection with the operation 308 below or as separate signaling.

The method 300 may include, at operation 308, sending one or more second instructions to the plurality of DC/DC converters 58 to cause the plurality of DC/DC converters 58 to operate based on a set of parameters that includes the direction and the amount of the power flow. For example, the ESM system 26 may provide the one or more second instructions directly to the DC/DC converters 58 via the software layer communication lines 68, or the ESM system 26 may provide the one or more second instructions to the BMSs 30 in each battery pack 20 and the BMSs 30 may provide the one or more instructions to the DC/DC converters 58.

The method 300 may include, at operation 310, performing one or more actions related to controlling the plurality of DC/DC converters 58. For example, the ESM system 26 may monitor the energy levels of the battery packs 20 (e.g., by querying the BMSs 30 for information related to the energy levels). The ESM system 26 may then determine to modify the direction and amount of the power flow for one or more battery packs 20, may determine to stop the rebalancing of power among battery packs 20, and/or may bring one or more battery packs 20 (or strings) back online or take one or more additional battery packs 20 (or strings) offline. The ESM system 26 may then provide one or more third instructions related to these operations to the DC/DC converter 58 and/or to the BMS 30.

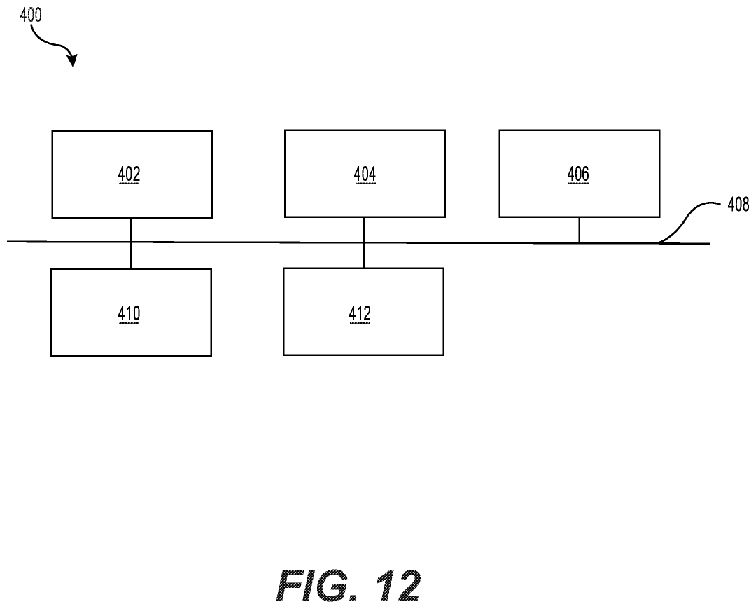

FIG. 12 illustrates example components of a computing device 400, according to the present disclosure. In particular, FIG. 12 is a simplified functional block diagram of a computing device 400 that may be configured as a device for executing methods of this disclosure, such as FIGS. 10 and 11. For example, the computing device may be configured as the ESM system 26, the BMS 30, a battery pack controller, the high voltage peripheral device or system 52, the low voltage peripheral device or system 56, and/or another device or system according to exemplary embodiments of the present disclosure. In various embodiments, any of the devices or systems described herein may be the computing device 400 illustrated in FIG. 12 and/or may include one or more of the computing devices 400.

As illustrated in FIG. 12, the computing device 400 may include a processor 402, a memory 404, an output component 406, a communication bus 408, an input component 410, and a communication interface 412. The processor 402 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the processor 402 includes one or more processors capable of being programmed to perform a function. The memory 404 may include a random access memory (RAM), a read only memory (ROM), and/or another type of dynamic or static storage device (e.g., a flash memory, a magnetic memory, and/or an optical memory) that stores information and/or instructions for use by the processor 402.

The output component 406 may include a component that provides output information from the computing device 400 (e.g., a display, a speaker, and/or one or more light-emitting diodes (LEDs)). The communication bus 408 may include a component that permits communication among the components of the computing device 400. The input component 410 may include a component that permits the computing device 400 to receive information, such as via user input (e.g., a touch screen display, a keyboard, a keypad, a mouse, a button, a switch, and/or a microphone). Additionally, or alternatively, the input component 410 may include a sensor for sensing information (e.g., a global positioning system (GPS) component, an accelerometer, a gyroscope, and/or an actuator). The communication interface 412 may include a transceiver-like component (e.g., a transceiver and/or a separate receiver and transmitter) that activates device 400 to communicate with other devices, such as via a wired connection, a wireless connection, or a combination of wired and wireless connections. The communication interface 412 may permit the computing device 400 to receive information from another device and/or provide information to another device. For example, the communication interface 412 may include a controller area network (CAN) bus, an Ethernet interface, an optical interface, a coaxial interface, an infrared interface, a radio frequency (RF) interface, a universal serial bus (USB) interface, a wireless local area network interface, a cellular network interface, and/or the like.

As noted above, the computing device 400 illustrated in FIG. 12 may perform one or more processes described herein. The computing device 400 may perform these processes based on the processor 402 executing software instructions stored by a non-transitory computer-readable medium, such as the memory 404 and/or another storage component. For example, the storage component may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. A computer-readable medium is defined herein as a non-transitory memory device. A memory device includes memory space within a single physical storage device or memory space spread across multiple physical storage devices.

Software instructions may be read into the memory 404 and/or a storage component from another computer-readable medium or from another device via the communication interface 412. When executed, software instructions stored in the memory 404 and/or the storage component may cause the processor 402 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

Certain embodiments described herein may provide various technological advantages or improvements. For instance, by including a DC/DC converter in a battery pack, certain embodiments may allow for power to be imported to, or exported from, a battery pack to rebalance stored energy levels across multiple battery packs without needing to connect an electric bus to external equipment. Thus, the re-balancing can be performed while the bus in in operation and/or automatically when the bus enters an idle state, which improves an efficiency of maintenance of a bus by reducing the need for certain types of maintenance efforts and/or reducing an amount of time that a bus has to be taken out of service for maintenance. In addition, this improves safety with respect to maintenance of the bus by reducing a need for maintenance personnel to interact with the battery system of the bus. Similarly, by actively monitoring and rebalancing stored energy levels of battery packs, certain embodiments described herein may provide for faster detection and correction of energy level imbalances, which can reduce or eliminate severe imbalances that might deactivate an electric bus or may allow for the bus to be returned to service faster as charge imbalances can be corrected while the bus is in operation.

Certain embodiments may provide for a system where batteries and charging can operate without external input from the electric bus. For example, with the batteries able to supply sufficient DC voltage to run pumps, keep contactors closed, and keep the low voltage battery system at a healthy level, the bus may not need to be powered on to charge or condition the high voltage batteries. Control of the charge port contactors may be provided by a charge controller and a separate path that may not need to go through the main DC load contactors in the electric bus. In addition, certain embodiments may provide vehicle-off operation efficiency gains in charging, and may satisfy operator needs for having, e.g., the interior lights and destination signs of the bus off while charging without needing specialty software to determine this activity (the operator may just turn the vehicle off before plugging it in at a charging station).

While principles of the present disclosure are described herein with reference to a battery pack that includes a DC/DC converter for electric buses, it should be understood that the disclosure is not limited thereto. Rather, the systems and methods described herein may be employed in any type of electric vehicle. Also, those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description. For example, while certain features have been described in connection with various embodiments, it is to be understood that any feature described in conjunction with any embodiment disclosed herein may be used with any other embodiment disclosed herein.

We claim:

1. A battery system, comprising:
at least one battery pack comprising a direct current to direct current (DC/DC) converter and at least one battery cell, wherein a positive terminal and a negative terminal of the at least one battery cell are electrically connected to a positive terminal and a negative terminal, respectively, associated with the DC/DC converter;
a high voltage bus bar electrically connected to the positive terminal and the negative terminal of the at least one battery cell;
a low voltage bus bar electrically connected to the DC/DC converter,
wherein the DC/DC converter is configured to at least one of import power to the at least one battery cell from the low voltage bus bar or export the power from the at least one battery cell to the low voltage bus bar;
a communication bus bar electrically connected to the DC/DC converter; and
at least one computing system configured to communicate with the DC/DC converter via the communication bus bar.

2. The battery system of claim 1, wherein the at least one computing system comprises:
a battery management system (BMS) within the at least one battery pack configured to communicate with the DC/DC converter and an energy storage management (ESM) system external to the at least one battery pack configured to communicate with the BMS.

3. The battery system of claim 1, wherein the positive terminal and the negative terminal associated with the DC/DC converter are controllable separate from control of the DC/DC converter.

4. The battery system of claim 1, wherein the at least one battery pack includes a plurality of battery packs and wherein the computing system is configured to configure a first subset of the plurality of battery packs to import power from the low voltage bus bar and a second subset of the plurality of battery packs to simultaneously export power to the low voltage bus bar.

5. The battery system of claim 1, wherein the battery system is included in an electric bus.

6. The battery system of claim 1, wherein the DC/DC converter is configured to import the power or export the power based on a set of parameters.

7. The battery system of claim 6, wherein the at least one computing system is configured to provide the set of parameters to the DC/DC converter via the communication bus bar.

8. A method of using a direct current to direct current (DC/DC) converter located within a battery pack of a battery system, the DC/DC converter being electrically connected to a low voltage bar and to one or more battery cells of the battery pack, the method comprising:
receiving, by a computing system, an instruction to activate the DC/DC converter; and
sending one or more instructions to the DC/DC converter, wherein the one or more instructions are associated with configuring the DC/DC converter at least to operate based on a set of parameters comprising a direction or an amount of power flow import to or export from the battery pack.

9. The method of claim 8, further comprising:
sending one or more other instructions to deactivate the operation of the DC/DC converter after sending the one or more instructions to the DC/DC converter.

10. The method of claim 8, further comprising:
sending one or more other instructions to modify the set of parameters after sending the one or more instructions to the DC/DC converter.

11. The method of claim 8, further comprising:
sending one or more other instructions to modify the direction or the amount of the power flow to or from the battery pack.

12. The method of claim 8, wherein the computing system comprises a battery management system (BMS) included in the battery pack or an energy storage management (ESM) system external to the battery pack.

13. The method of claim 8, wherein the sending of the one or more instructions further comprises:
sending the one or more instructions via one or more software layer communication lines or via one or more hardware layer communication lines.

14. The method of claim 8, further comprising:
receiving, from the DC/DC converter, one or more metrics related to the operation of the DC/DC converter; and
sending, to the DC/DC converter, one or more other instructions to modify the operation of the DC/DC converter based on the one or more metrics.

15. A method for balancing stored energy levels among a plurality of battery packs of a battery system, comprising:
receiving, by a computing system, one or more first instructions to activate a plurality of direct current to direct current (DC/DC) converters,
wherein each of the plurality of battery packs includes at least one of the plurality of DC/DC converters;
receiving information related to the stored energy levels of the plurality of battery packs;
determining, for each of the plurality of battery packs, a direction of power flow and an amount of the power flow to balance the stored energy levels among the plurality of battery packs; and
sending one or more second instructions to each of the plurality of DC/DC converters, wherein the one or more second instructions are associated with configuring the each of the plurality of DC/DC converters to operate based on a set of parameters comprising the direction and the amount of the power flow.

16. The method of claim 15, wherein the computing system comprises an energy storage management (ESM) system.

17. The method of claim 15, wherein the plurality of battery packs includes a first subset of battery packs and a second subset of battery packs, and
wherein the determining of the direction of the power flow and the amount of the power flow comprises:
determining the direction of the power flow and the amount of the power flow such that the amount of the power flow from the first subset of battery packs is equal to the amount of the power flow from the second subset of battery packs.

18. The method of claim 15, wherein the plurality of battery packs includes at least one subset of battery packs, and wherein the determining of the direction of the power flow and the amount of the power flow comprises determining different directions of the power flow and different amounts of the power flow for at least two battery packs in a same subset of battery packs.

19. The method of claim 15, further comprising:
monitoring the stored energy levels of the plurality of battery packs; and
modifying the balancing of the stored energy levels based on the monitoring.

20. The method of claim 15, wherein the direction of the power flow includes an import of power from a low voltage bus bar or an export of the power to the low voltage bus bar.
